(19) United States
(12) Patent Application Publication
(10) Pub. No.: US 2010/0045959 A1
(43) Pub. Date: Feb. 25, 2010

(54) PHOTOLITHOGRAPHY APPARATUS WITH LEVELING ELEMENT AND METHOD FOR LEVELING A WAFER

(76) Inventors: Shin-Hsiang Chou, Hsinchu (TW); Kuo-Hsing Teng, Hsinchu (TW); Yang-Kuao Kuo, Hsinchu (TW)

Correspondence Address: Muncy, Geissler, Olds & Lowe, PLLC, P.O. BOX 1364, FAIRFAX, VA, 22038-1364, US

(21) Appl. No.: 12/195,870

(22) Filed: Aug. 21, 2008

(51) Int. Cl. G03B 27/58; H04N 7/18

(52) U.S. Cl. 355/72; 348/88; 348/E07.085

(57) ABSTRACT

A method for leveling a wafer in a photolithography apparatus is disclosed, including inputting a wafer into the photolithography apparatus to be supported by a chuck, using at least three image capture devices to capture images of corresponding alignment marks on the wafer; and leveling the wafer according to the clarity of the images of the corresponding alignment marks on the wafer captured by the image capture device.

### BACKGROUND OF THE INVENTION

1. Field of the Invention

This invention relates to a photolithography apparatus, and more particularly relates to a method for leveling a semiconductor wafer during the photolithography process.

2. Description of the Related Art

Various techniques have previously been used to manufacture integrated circuits on semiconductor wafers. Optical projection lithography using ultra-violet light is one of the more common techniques. Projection lithography techniques use a mask which is several times larger than the integrated circuit. The pattern or circuit is projected from a distance onto a photoresist on a semiconductor wafer.

A photolithography apparatus operates by projecting an image containing a portion of an integrated circuit onto chips on a semiconductor wafer by using a mask or exposure field. Before exposure of the photolithography process, it is required that the wafer for the mask be leveled and the wafer be parallel.

FIG. 1A˜FIG. 1C show a leveling procedure of a conventional SUSS aligner tool. As shown in FIG. 1A, the wafer 102 leveling method is accomplished by wedge error compensation (WEC), which includes small balls 106 substantially having diameters of about 2 mm, disposed on a chuck 108. As shown in FIG. 1B, after the wafer 102 is set on the chuck 108, the chuck 108 rises till the balls 106 touch the mask 104 for leveling the wafer 102, while assuming that the mask 104 and the wafer 102 are parallel with each other. Next, referring to FIG. 1C, the chuck 108 moves down and then rises again to set up an exposure procedure. However, the wafer 102 leveling method has some drawbacks. Referring to FIG. 1D, during exposure, the wafer 102 is coated with a photoresist, and when the photoresist is not coated uniformly and particles 110 are disposed thereon, the wafer 102 leveling method may cause particles 110 or photoresist to stick onto the mask 104. The conventional photolithography apparatus cannot eliminate the preceding drawback.

In addition, as the line width for integrated circuits used in semiconductor devices becomes smaller and smaller, accuracy of the leveling of the ball, which is at the mm level, cannot meet requirements of device processes requiring a minimum exposure gap of about 10 μm. Therefore, a novel method for leveling a wafer and photolithography with a leveling element are required.

### BRIEF SUMMARY OF INVENTION

According to the issues described, the invention provides a method for leveling a wafer in a photolithography apparatus, comprising inputting a wafer into the photolithography apparatus to be supported by a chuck, using at least three image capture devices to capture images of corresponding alignment marks on the wafer; and leveling the wafer according to the clarity of the images of the corresponding alignment marks on the wafer captured by the image capture device.

The invention further provides a photolithography apparatus with a novel element or procedure for leveling a wafer, comprising a chuck for supporting a wafer; and at least three image capture devices for capturing images of corresponding alignment marks on the wafer arranged at three corners of the chuck in a triangular state. The three image capture devices are wafer leveling elements of the photolithography apparatus.

### BRIEF DESCRIPTION OF DRAWINGS

The invention can be more fully understood by reading the subsequent detailed description and examples with references made to the accompanying drawings, wherein:

FIG. 1A˜FIG. 1C show a leveling procedure of a conventional SUSS aligner tool.

FIG. 1D shows an issue of a conventional SUSS aligner tool.

FIG. 2A˜FIG. 2B show a method for leveling a semiconductor wafer during the photolithography process of an embodiment of the invention.

FIG. 2C show a schematic plan view of arrangement of cameras of an embodiment of the invention.

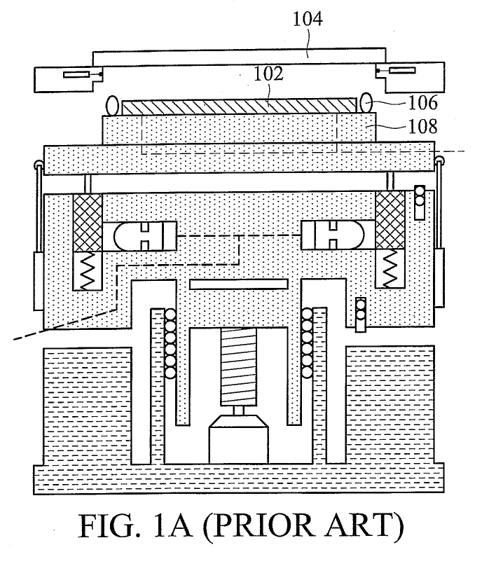

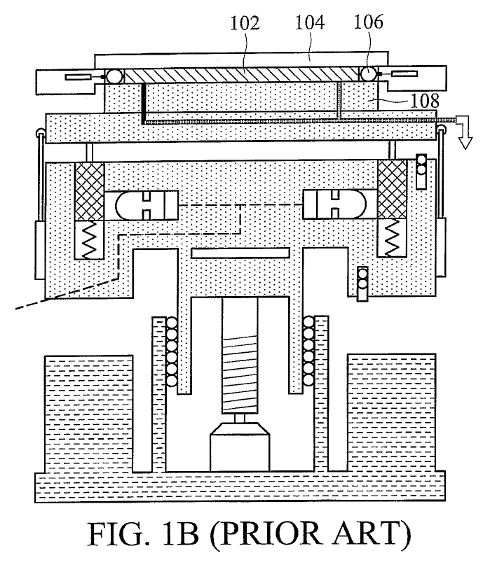

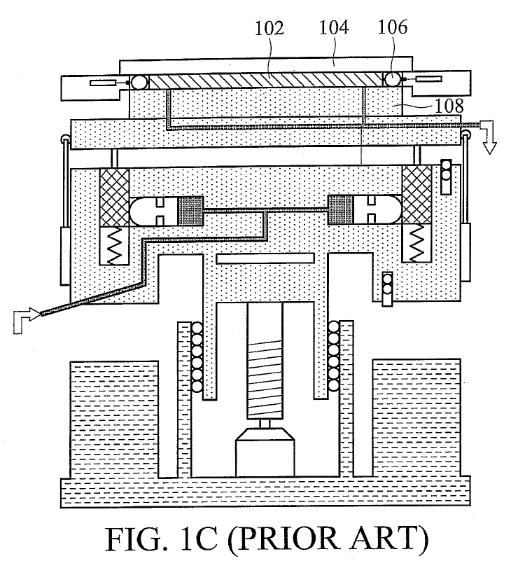

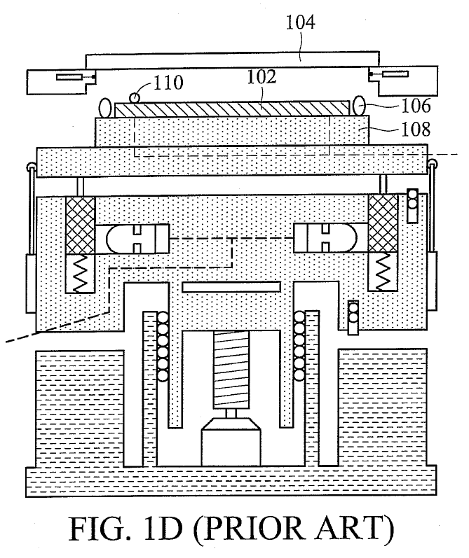

### DETAILED DESCRIPTION OF INVENTION

The following description is of the contemplated mode of carrying out the invention. This description is made for the purpose of illustrating the general principles of the invention and should not be taken in a limiting sense, not for limiting the invention.

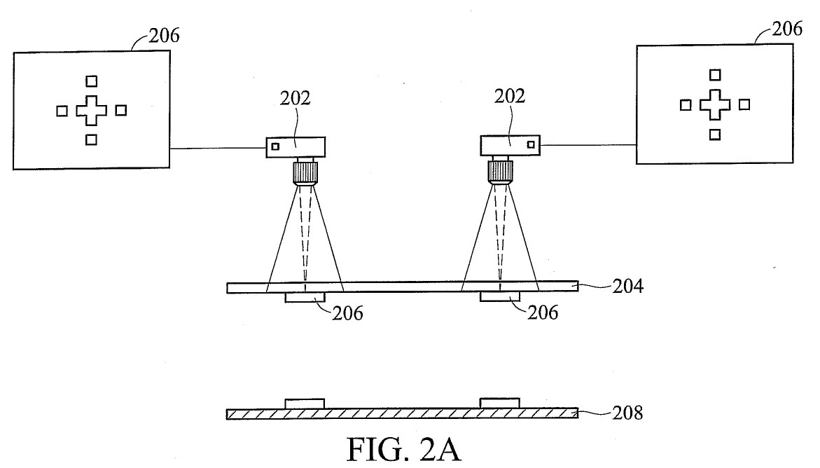

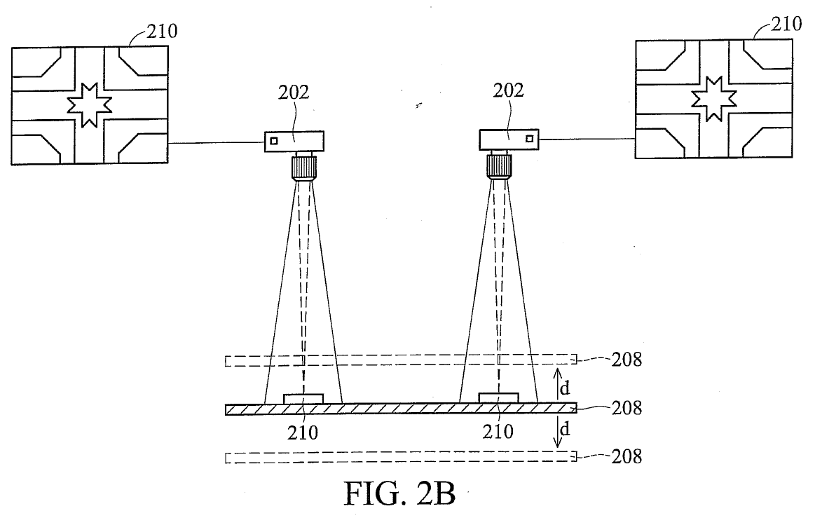

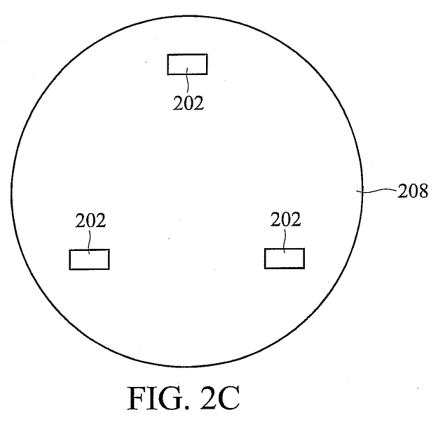

FIG. 2A˜FIG. 2B show a method for leveling a semiconductor wafer 208 during the photolithography process of an embodiment of the invention. First, referring to FIG. 2A and FIG. 2C, wherein FIG. 2C shows a schematic plan view of arrangement of cameras 202, at least three cameras 202 are disposed over a mask 204 and a wafer 208 in the photolithography apparatus, and specifically the three cameras 202 are arranged at three corners of the chuck (not shown) in a triangular state. Referring to FIG. 2A, before the exposure step, the mask 204 is inputted into the lithography apparatus and is aligned using the cameras 202 to find the positions of the alignment mark 206 on the mask 204. Next, referring to FIG. 2B, the mask 204 is removed and then the wafer 208 is inputted. The wafer 208 is aligned using the cameras 202 to find the positions of the alignment mark 206 on the wafer 208, and the wafer 208 is substantially leveled according to focus of the alignment marks 210 on the wafer 208 captured by the cameras 202. In an embodiment of the invention, the wafer 208 is aligned and leveled simultaneously using the cameras 202 capturing the images the alignment marks 210 on the wafer 208. The detailed procedure for leveling the wafer 208 on the chuck will be discussed below.

After the wafer 208 is inputted into the photolithography apparatus, the cameras 202 focus on the alignment marks 210 on the wafer 208 and the clarity of the picture of the alignment marks 210 captured by the cameras 202 are defined by degree. For example, the embodiment would be set if clarity of the picture of the alignment mark 210 captured by the cameras 202 is over 80 degrees. Following, the photolithography apparatus will receive a signal from a computer which represents that the alignment mark 210 on the wafer 208 is in the focus d range. Alternatively, if the clarity of the picture of the alignment mark 210 captured by the cameras 202 is not over 80 degrees, it represents that the alignment mark 210 is not in focus and the photolithography apparatus will receive a signal which represents that the alignment mark 210 on the wafer 208 is not in the focus d range. Therefore, the computer will inform the chuck to adjust the wafer 208. Furthermore, when all of the three cameras 202 capture clear pictures of the three alignment marks 210 on three corners of the wafer 208, which means that clarity of the three picture will all be over 80 degrees, the photolithography apparatus will receive a signal which represents that the wafer 208 is to be leveled. Meanwhile, when clarity of at least one or two of the three pictures is not over 80 degrees, it represents that the wafer 208 is still not leveled and the computer will inform the chuck to adjust the wafer 208. It is noted that the focus range d of the camera 202 is about 20 μm which is much less than the diameters of the leveling balls. Hence, the precision of the leveling method of the embodiment can be greatly improved to meet requirements of devices.

After leveling the wafer, the mask can be inputted into the photolithography apparatus, and the chuck would move down and then rises again to set up exposure. Next, an exposure step is performed to transfer pattern from the mask to the layers on the wafer. It is noted that the procedure in the paragraph is a standard photolithography process and is not described in further detail.

The embodiment of the invention at least has the following advantages. The embodiment of the invention does not require balls to be mounted on the WEC component to touch the mask, such that when uniformity of the wafer or the layer on the wafer is not good, or some particles have fallen on the wafer, stick issues should not occur. Further, the embodiment uses focus of cameras to check and level the wafer. Since focus of cameras is μm level, the embodiment has better precision and sensitivity than the conventional art.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for leveling a wafer in a photolithography apparatus, comprising:
inputting a wafer into the photolithography apparatus to be supported by a chuck;
using at least three image capture devices to capture images of corresponding alignment marks on the wafer; and
leveling the wafer according to the clarity of the images of the corresponding alignment marks on the wafer captured by the image capture device.

2. The method for leveling a wafer in a photolithography apparatus as claimed in claim 1, wherein the image capture devices are cameras.

3. The method for leveling a wafer in a photolithography apparatus as claimed in claim 2, wherein the cameras have focus range of about 20 μm.

4. The method for leveling a wafer in a photolithography apparatus as claimed in claim 1, wherein the step of leveling the wafer according to the clarity of the images captured by the image capture device comprises:
checking if clarity of the images of the corresponding alignment marks on the wafer captured by the image capture devices are all over a certain degrees; and
if clarity of one of the images captured by the image capture device is not over the certain degrees, adjusting the chuck to level the wafer.

5. The method for leveling a wafer in a photolithography apparatus as claimed in claim 4, wherein if clarity of all the images of the corresponding alignment marks on the wafer captured by the image capture device is over the certain degree, the chuck is stopped from begin adjusted.

6. The method for leveling a wafer in a photolithography apparatus as claimed in claim 4, wherein the certain degree is 80 degrees.

7. The method for leveling a wafer in a photolithography apparatus as claimed in claim 1, further comprising inputting a mask into the photolithography apparatus and using at least one of image capture device to find position of an alignment mark on the mask to align the mask before inputting the wafer into the photolithography apparatus.

8. The method for leveling a wafer in a photolithography apparatus as claimed in claim 1, wherein the method further comprises using the image capture devices to find the alignment marks on the wafer to align positions of the wafer simultaneously when leveling the wafer.

9. The method for leveling a wafer in a photolithography apparatus as claimed in claim 1, wherein three image capture devices are arranged at three corners of the chuck in a triangular state.

10. A photolithography apparatus, comprising:
a chuck for supporting a wafer; and
at least three image capture devices for capturing images of corresponding alignment marks on the wafer arranged at three corners of the chuck in a triangular state.

11. The photolithography apparatus as claimed in claim 10, wherein the image capture devices are cameras.

12. The photolithography apparatus as claimed in claim 10, wherein the cameras have focus range of about 20 μm.

13. The photolithography apparatus as claimed in claim 10, wherein the three image capture devices are wafer leveling elements of the photolithography apparatus.
